(19) United States
(12) Patent Application Publication
(10) Pub. No.: US 2011/0042043 A1
(43) Pub. Date: Feb. 24, 2011

(54) HEAT DISSIPATION MODULE

(75) Inventor: RUNG-AN CHEN, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: FOXCONN TECHNOLOGY CO., LTD., Tu-Cheng (TW)

(21) Appl. No.: 12/604,411

(22) Filed: Oct. 23, 2009

(30) Foreign Application Priority Data
Aug. 19, 2009 (CN) 200910305784.8

(51) Int. Cl. F28D 15/04; G06F 1/20; F28D 21/00; F28F 7/00

(52) U.S. Cl. 165/104.26; 165/121; 165/185

(57) ABSTRACT

A heat dissipation module includes a heat pipe having a condensing section, a centrifugal fan defining an air outlet and a fin assembly. The fin assembly includes a plurality of fins stacked together and is thermally attached to the condensing section of the heat pipe. The fin assembly is located at the air outlet of the centrifugal fan. At least some fins of the fin assembly have a height decreasing along the condensing section of the heat pipe. The fin assembly defines a spared space at a bottom side of the fin assembly corresponding to the at least some fins.

### BACKGROUND

1. Technical Field

The present disclosure relates to heat dissipation modules, and particularly to a heat dissipation module for use in a notebook computer to dissipate heat generated by heat-generating electronic components of the notebook computer.

2. Description of Related Art

With continuing development of notebook computer technology, heat-generating electronic components such as CPUs (central processing units) are generating more and more heat which requires immediate dissipation. Generally, heat dissipation modules are attached to the electronic components to provide such heat dissipation. A conventional heat dissipation module includes a fin assembly, a heat pipe and a centrifugal fan. The heat pipe connects the electronic component with the fin assembly to transfer heat from the electronic component to the fin assembly. The centrifugal fan defines an air outlet facing the fin assembly to provide a forced airflow to cool the fin assembly. However, the notebook computer is becoming more and more compact and a plurality of other electronic components are integrated in the notebook computer in order to make the notebook computer more powerful. These added electronic components will interfere with the heat dissipation module disposed in the notebook computer.

Therefore, a heat dissipation module is desired to overcome the above described shortcoming

### BRIEF DESCRIPTION OF THE DRAWINGS

FIG. 1 is an assembled, isometric view of a heat dissipation module in accordance with a first embodiment.

FIG. 2 is a front side view of the heat dissipation module of FIG. 1, with a centrifugal fan thereof being omitted.

FIG. 3 is an assembled, isometric view of a heat dissipation module in accordance with a second embodiment.

FIG. 4 is a front side view of the heat dissipation module of FIG. 3, with a centrifugal fan thereof being omitted.

### DETAILED DESCRIPTION

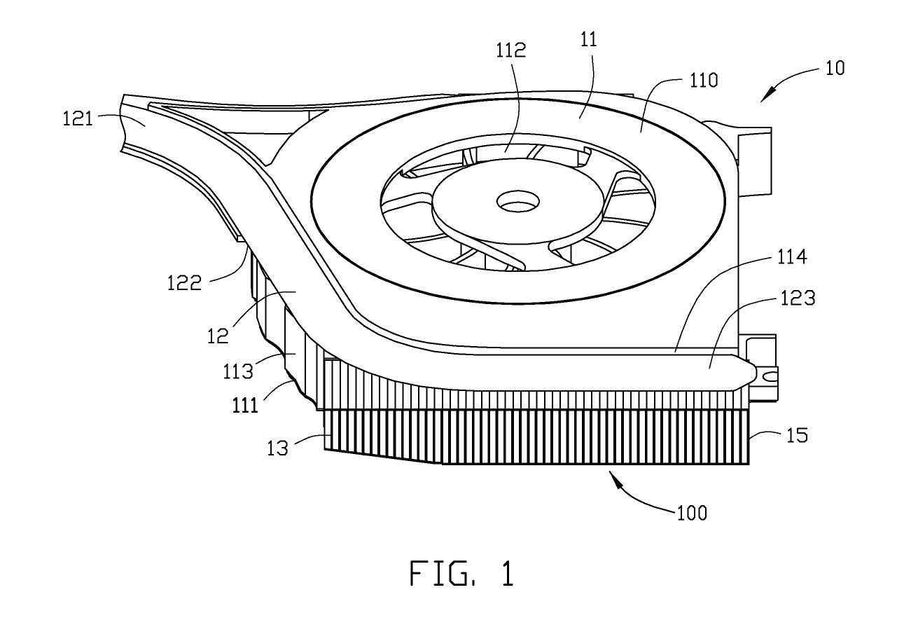

FIG. 1 shows a heat dissipation module 10 in accordance with a first embodiment of the present disclosure. The heat dissipation module 10 includes a centrifugal fan 11, a heat pipe 12, and a fin assembly 100. The heat dissipation module 10 is particularly suitable for use in a notebook computer for dissipating heat of heat-generating electronic components of the notebook computer.

The centrifugal fan 11 includes a top plate 110, a bottom plate 111 and a sidewall 113 interconnecting the top plate 110 with the bottom plate 111. The centrifugal fan 11 defines an air inlet 112 at the top plate 110 and an air outlet 114 at the sidewall 113, wherein the air outlet 114 is perpendicular to the air inlet 112. The heat pipe 12 is flat, including a planar top surface 121 and a planar bottom surface 122. The heat pipe 12 includes an evaporating section for absorbing heat from an electronic component of the notebook computer, and a condensing section 123 located at a top side of the air outlet 114 of the centrifugal fan 11. The condensing section 123 of the heat pipe 12 is parallel to the air outlet 114 of the centrifugal fan 11.

The fin assembly 100 is located at the air outlet 114 of the centrifugal fan 11. The fin assembly 100 includes a first fin unit 13 at a left side thereof and a second fin unit 15 at a right side thereof. The second fin unit 15 is connected to a right side of the first fin unit 13. The second fin unit 15 has a height in an axial direction of the centrifugal fan 11 greater than that of the first fin unit 13. A top side of the first fin unit 13 is coplanar with a top side of the second fin unit 15.

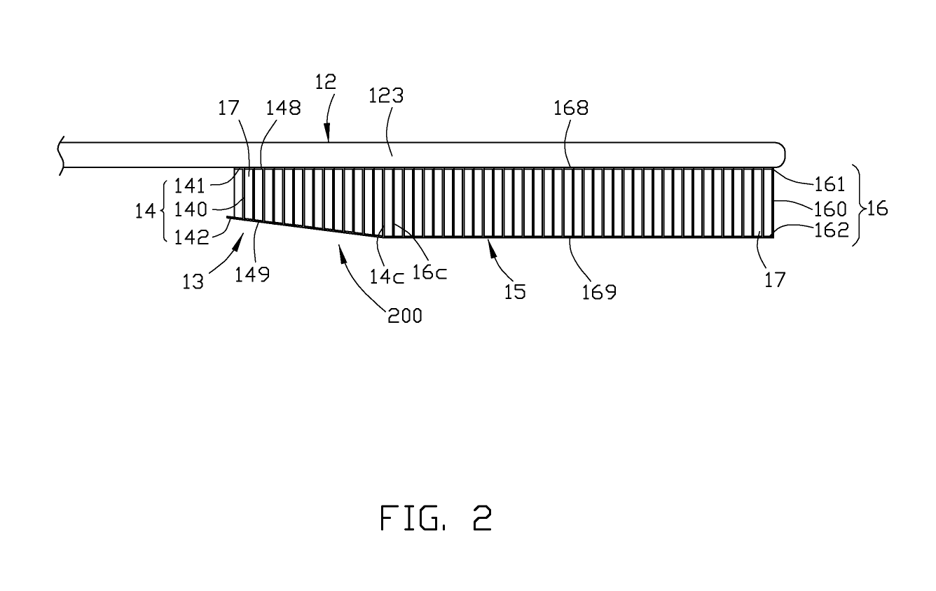

Referring to FIG. 2, the first fin unit 13 includes a plurality of parallel first fins 14 stacked together along the condensing section 123 of the heat pipe 12. The first fins 14 of the first fin unit 13 have a height decreasing along a right-to-left direction. Each of the first fins 14 includes a main body 140, and top and bottom flanges 141, 142 respectively extending leftward from top and bottom edges of the main body 140. The top and bottom flanges 141, 142 of each first fin 14 of the first fin unit 13 are integrally formed with the main body 140. The top and bottom flanges 141, 142 of each first fin 14 of the first fin unit 13 abut the main body 140 of a neighboring left first fin 14, and an air passage 17 is defined between every two neighboring first fins 14 of the first fin unit 13. The top flanges 141 of the first fins 14 cooperatively form a planar upper surface 148 at the top side of the first fin unit 13. The bottom flanges 142 of the first fins 14 cooperatively form an inclined lower surface 149 at the bottom side of the first fin unit 13.

The second fin unit 15 includes a plurality of second fins 16 stacked together along the condensing section 123 of the heat pipe 12. The second fins 16 of the second fin unit 15 have a same height. The second fins 16 of the second fin unit 15 each include a main body 160, and top and bottom flanges 161, 162 extending leftward from top and bottom edges of the main body 160. The top and bottom flanges 161, 162 of each second fin 16 of the second fin unit 15 abut the main body 160 of a neighboring left second fin 16, and every two neighboring second fins 16 of the second fin unit 15 cooperatively define an air passage 17 therebetween. The top flanges 161 of the second fins 16 cooperatively form a planar upper surface 168 at the top side of the second fin unit 15. The bottom flanges 162 of the second fins 16 cooperatively form a horizontally planar lower surface 169 at the bottom side of the second fin unit 15. The planar upper surface 148 of the first fin unit 13 is coplanar with the planar upper surface 168 of the second fin unit 15.

When assembled, the upper surface 168 of the second fin unit 15 and the upper surface 148 of the first fin unit 13 are attached to the bottom surface 122 of the heat pipe 12 at the condensing section 123. The second fin unit 15 is located at a right side of the first fin unit 13.

A leftmost second fin 16c of the second fin unit 15 is located adjacent to a rightmost first fin 14c of the first fin unit 13. The rightmost first fin 14c of the first fin unit 13 has a height the same as that of the leftmost second fin 16c of the second fin unit 15. Except the rightmost first fin 14c, the other first fins 14 of the first fin unit 13 has a smaller height than any one of the second fins 16 of the second fin unit 15. The top flange 161 of the leftmost second fin 16c of the second fin unit 15 abuts a top end of the main body 140 of the rightmost first fin 14c of the first fin unit 13. The bottom flange 162 of the leftmost second fin 16c of the second fin unit 15 abuts a bottom end of the main body 140 of the rightmost first fin 14c of the first fin unit 13.

During operation, the evaporating section of the heat pipe 12 receives heat from the electronic component and transfers the heat to the condensing section 123 of the heat pipe 12, and then to the first and second fin units 13, 15 such that air in the air passages 17 is heated. The centrifugal fan 11 generates a forced airflow to blow away the heated air from the air passages 17 of the first and second fin units 13, 15.

Since the first fins 14 of the first fin unit 13 have a height decreasing along the condensing section 123 of the heat pipe 123, the first fin unit 13 defines a triangularly-shaped spared space 200 at a bottom side of the first fin unit 13. The spared space 200 can be used to receive other electronic components such as the capacitors mounted on the PCB of the notebook computer whereby these other electronic components will not be interfering with the heat dissipation module 10 and the notebook computer can be made to have a compact structure.

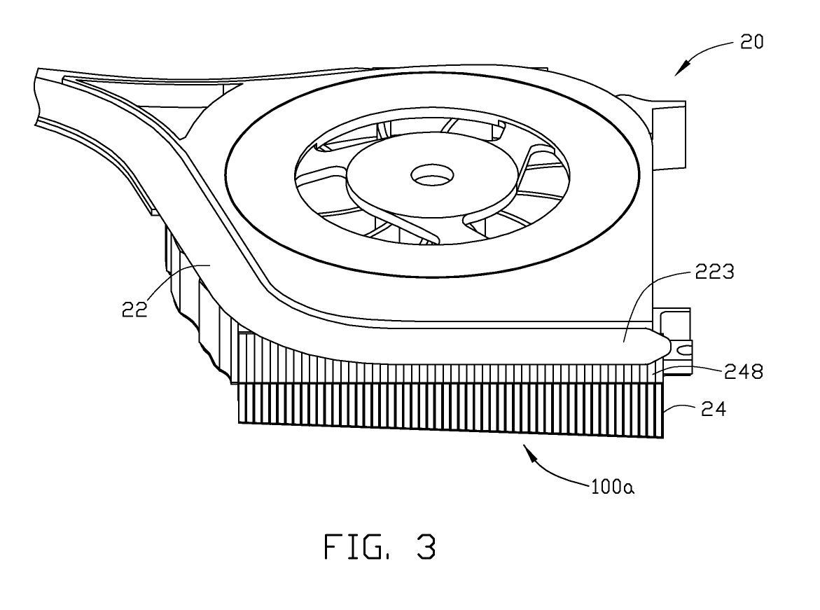

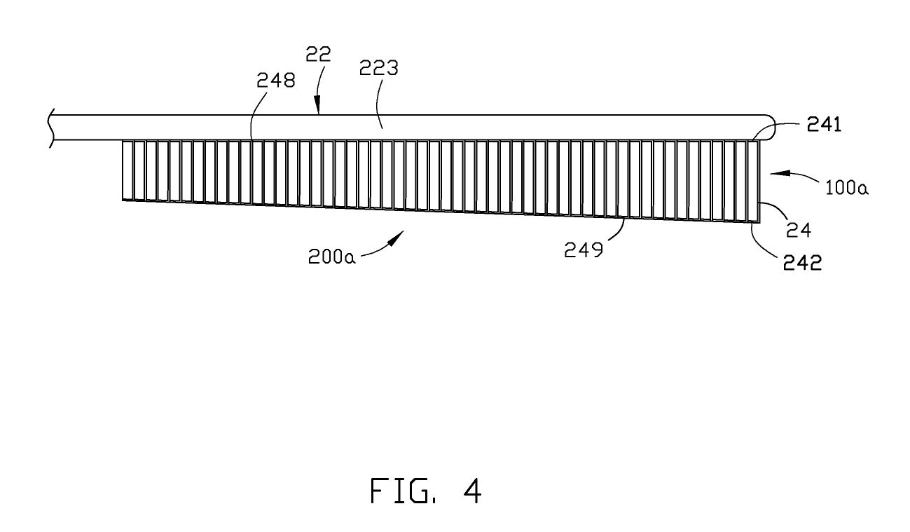

FIGS. 3-4 show a heat dissipation module 20 in accordance with an alternative embodiment of the present disclosure. The heat dissipation module 20 differs from the heat dissipation module 10 of the previous embodiment only in that heights of all of the fins 24 of the fin assembly 100a decrease along the condensing section 223 of the heat pipe 22 along a right-to-left direction. The top flanges 241 of the fins 24 of the fin assembly 100a cooperatively form a planar upper surface 248 at the top side of the fin assembly 100a. The bottom flanges 242 of the fins 24 of the fin assembly 100a cooperatively form an inclined lower surface 249 at the bottom side of the fin assembly 100a thereby defining a triangularly-shaped spared space 200a at the bottom side of the fin assembly 100a.

It is to be understood, however, that even though numerous characteristics and advantages of the disclosure have been set forth in the foregoing description, together with details of the structure and function of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A heat dissipation module, comprising:
a heat pipe having a condensing section;
a centrifugal fan defining an air outlet; and
a fin assembly comprising a plurality of fins stacked together and being thermally attached to the condensing section of the heat pipe, the fin assembly being located at the air outlet of the centrifugal fan, at least some fins of the fin assembly having a height decreasing along the condensing section of the heat pipe, the fin assembly defining a spared space at a bottom side of the fin assembly corresponding to the at least some fins.

2. The heat dissipation module of claim 1, wherein the fin assembly includes a first fin unit and a second fin unit adjacent to the first fin unit, fins of the first fin unit have a height decreasing along the condensing section of the heat pipe, and fins of the second fin unit have a same height.

3. The heat dissipation module of claim 2, wherein the heat pipe is flat and comprises a planar bottom surface, a top side of the first fin unit is coplanar with a top side of the second fin unit, the first fin unit has a planar upper surface at the top side of the first fin unit, the second fin unit has a planar upper surface at the top side of the second fin unit, and the planar upper surface of the first fin unit and the planar upper surface of the second fin unit are attached to the planar bottom surface of the heat pipe.

4. The heat dissipation module of claim 3, wherein the first fin unit comprises a first fin adjacent to and connected with the second fin unit, the second fin unit comprises a second fin adjacent to and connected with the first fin unit, and the first fin has a height the same as the second fin.

5. The heat dissipation module of claim 3, wherein the first fin unit comprises an inclined lower surface at a bottom side of the first fin unit, the second fin unit comprises a horizontally planar lower surface at a bottom side of the first fin unit, and the inclined lower surface of the first fin unit is connected with the horizontally planar lower surface of the second fin unit.

6. The heat dissipation module of claim 1, wherein the heat pipe is flat and comprises a planar bottom surface, the fin assembly has a planar upper surface at a top side of the fin assembly, and the planar upper surface of the fin assembly is attached to the planar bottom surface of the heat pipe.

7. The heat dissipation module of claim 1, wherein all of the fins of the fin assembly have a height decreasing along the condensing section of the heat pipe.

8. The heat dissipation module of claim 1, wherein the spared spaced is triangularly-shaped.
